(19) United States
(12) Patent Application Publication
(10) Pub. No.: US 2010/0033631 A1
(43) Pub. Date: Feb. 11, 2010

(54) DIGITAL PHOTO FRAME AND IMAGE DISPLAYING METHOD THEREOF

(75) Inventors: Ming-Feng Tsai, Tu-Cheng (TW); Cheng-Hao Chou, Tu-Cheng (TW); Kuan-Hong Hsieh, Tu-Cheng (TW); Xiao-Guang Li, Shenzhen City (CN); Guang-Jin Li, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/331,413

(22) Filed: Dec. 9, 2008

(30) Foreign Application Priority Data
Aug. 8, 2008 (CN) 200810303607.1

(51) Int. Cl. H04N 5/50

(52) U.S. Cl. 348/559

(57) ABSTRACT

A method for displaying image is provided. The method includes: providing at least one image display mode, the image display mode defines a total number of images displayed on a display, a size of each of display areas, and an duration of displaying image on the biggest possible display area; obtaining images and the image display mode; configuring one or more display areas according to the image display mode; and displaying images on the biggest possible display area in a special order according to the duration.

### TECHNICAL FIELD

The disclosure relates to a digital photo frame capable of displaying images in display areas and method thereof.

### DESCRIPTION OF RELATED ART

Digital photo frames are designed for displaying digital images without the need to print the digital images out and are in people's favors. As advances in microprocessor and other technologies continue to improve the performance of various electronic components, digital photo frames become more compact and more powerful, and are gradually replacing traditional image frames.

As we known, digital images play an important role in people's life. A digital photo frame is capable of displaying different images on a display at the same time. When a digital photo frame displays many images on a display, each of the images will be displayed in a small portion of display areas, however, it will affect enjoyment by the people viewing the images. Therefore, what is needed is a digital photo frame capable of displaying image in the biggest display area and method thereof.

### SUMMARY

A digital photo frame capable of displaying images in the biggest display area and other display areas is provided, the digital photo frame includes a memory, a display, an input unit and a processor.

The memory is configured for storing image display modes, wherein each of image display modes defines a total count of images displayable on a display, a size of each of display areas, and a duration to display image in the biggest display area.

The processor connected with the memory, the display and the input unit, includes a reading module, an assigning module, and a display module. The reading module is configured for obtaining images and a image display mode from the memory; the assigning module is configured for generating one or more display areas according to the obtained image display mode; the display module is configured for displaying images in the biggest display areas and other display areas in a special order according to the obtained image display mode.

Other advantages and novel features will be drawn from the following detailed description of the preferred embodiment with reference to the attached drawings.

### BRIEF DESCRIPTION OF THE DRAWINGS

The components of the drawings are not necessarily drawn to scale, the emphasis instead being placed upon clearly illustrating the principles of a digital photo frame. Moreover, in the drawings, like reference numerals designate corresponding parts throughout several views.

FIG. 1 is a block diagram of a digital photo frame in accordance with an exemplary embodiment.

FIG. 2 is a flowchart for a method of displaying images in display areas in accordance with an exemplary embodiment.

FIG. 3 is an exemplary schematic diagram illustrating displaying images in the biggest display area and other display areas in accordance with an exemplary embodiment.

FIG. 4 is an exemplary schematic diagram illustrating a predetermined order that displaying images in a one-by-one displaying manner in accordance with an exemplary embodiment.

FIG. 5 is an exemplary schematic diagram illustrating a predetermined order that displaying images in a first-in-first-out displaying manner in accordance with an exemplary embodiment.

### DETAILED DESCRIPTION OF EMBODIMENT

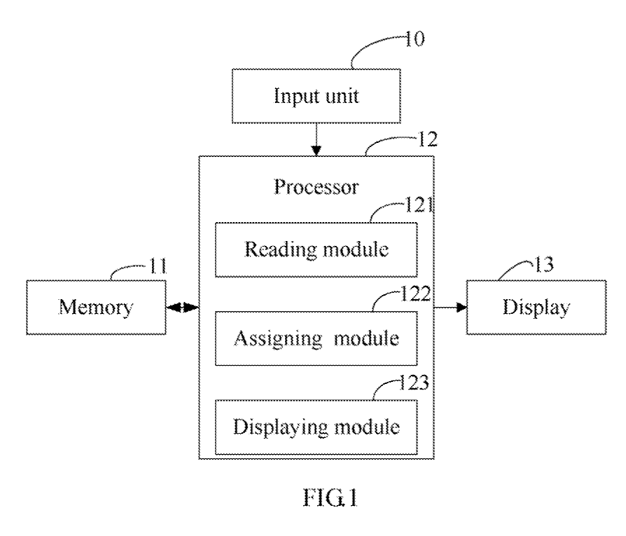

FIG. 1 is a block diagram of a hardware infrastructure of a digital photo frame in accordance with an exemplary embodiment. The digital photo frame includes at least one input unit 10, a memory 11, a processor 12, and a display 13.

The memory 11 is configured for storing image files and image display modes. Each of the image display modes defines a total count of images displayable on the display 13, a size of each of display areas, displaying order, and a duration to display an image in the biggest display area. The image display modes can also define aspect ratio, brightness, color, angle view of an image, and other image parameters. The image display mode can be a default one or a user-defined one.

For the purpose of easy understanding, in an exemplary embodiment, the default image display mode defines that the total count of the images displayable on the display 13 is 5, the duration of displaying in the biggest display area is 0.5 seconds, the size of the biggest display area as 6.0 cm(H) by 7.5 cm(W), and the size of each of the other display areas is 2.5 cm(H) by 3.75 cm(W). In another exemplary embodiment, the image display mode that is user-defined defines the total count of images displayable on the display 13 is 3, the duration of displaying in the biggest display area as 1.0 seconds, the size of the biggest display area is 6.75 cm(H) by 9.0 cm(W), and the size of each of the other display areas is 3.75 cm(H) by 5.0 cm(W).

The processor 12, connected with the memory 11, the input unit and the display, includes a reading module 121, an assigning module 122, and a displaying module 123.

The reading module 121 is configured for obtaining images and one of the image display modes from the memory 11. The assigning module 122 is configured for configuring one or more display areas according to the image display mode. The displaying module 123 is configured for displaying images in the display areas in a predetermined displaying order according to the image display mode.

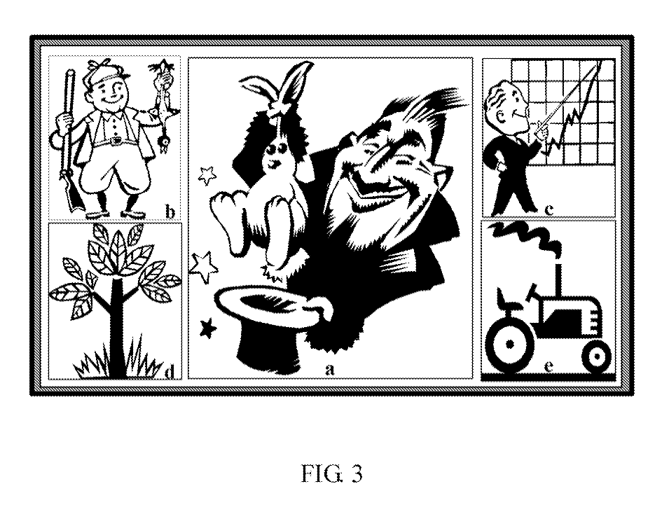

For the purpose of easy understanding the predetermined displaying order, referring to an exemplary embodiment of FIG. 3, image a, image b, image c, image d, and image e are displayed in the first display area, the second display area, the third display area, the forth display area, and the fifth display area respectively, wherein the first display area is the biggest display area. When displaying images, the display module 123 displays a new image in the biggest display area replacing an old image therein, and displays the old image in other display areas in a predetermined manner, wherein “new image” described refers to an image that has not yet been displayed, and “old image” refers to an image that has been displayed in the biggest display area.

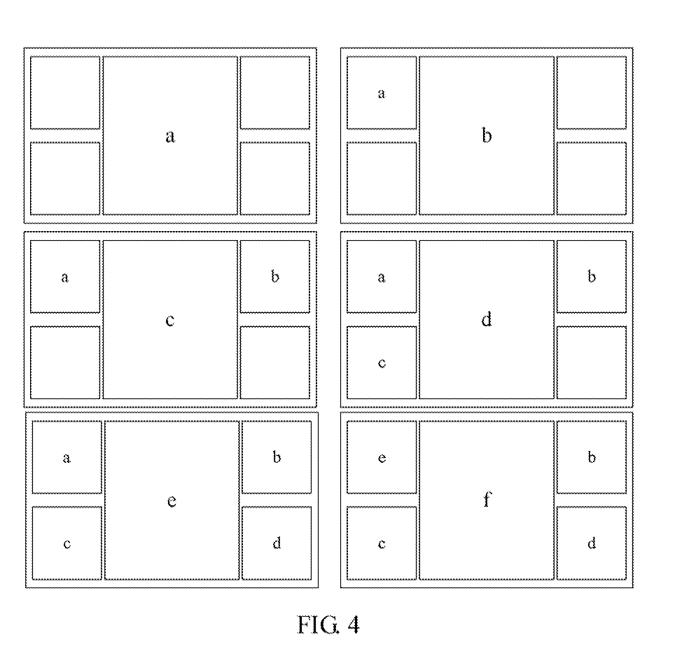

In the first exemplary embodiment, the display module 123 displays the old image from the biggest display area to one of the other display areas in one-by-one manner (see FIG. 4). For example, after a predetermined duration, the display module 123 displays the new image (e.g., image b) in the biggest display area replacing the old image (e.g., image a), and displays image a in the second display area. After another duration, the display module 123 displays the new image (e.g., image c) in the biggest display area replacing the old image (image b), and displays image b in third display area. After a third duration, the display module 123 displays the new image (e.g., image d) in the biggest display area replacing the old image (image c), and displays image c in the fourth display area. After a fourth duration, the display module 123 displays the new image (e.g., image e) in the biggest display area replacing the old image (e.g., image d), and displays image d in the fifth display area. Therefore, if there are more new images to be displayed on the condition that all the display areas have images therein, the display module 123 continues to display the new images in the one-by-one manner as described above.

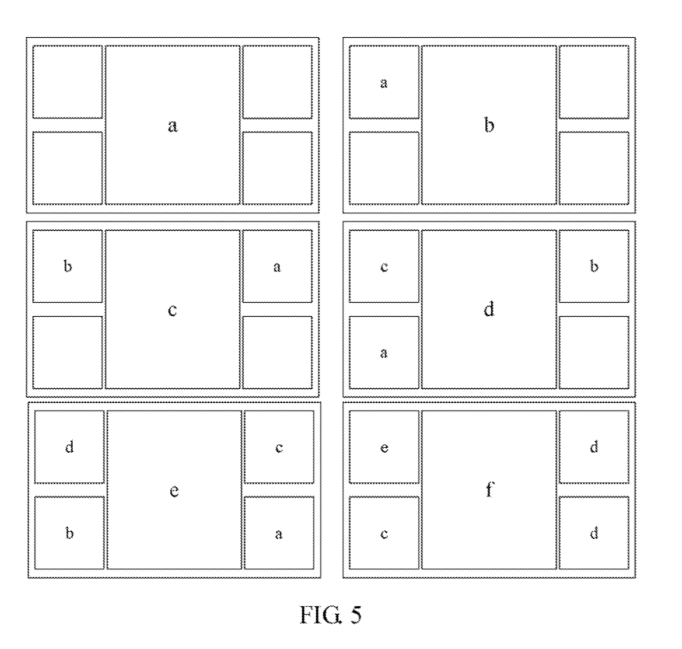

In a second exemplary embodiment, the display module 123 displays the old image from the biggest display area to one of the other display areas in first-in-first-out manner (see FIG. 5). For example, after a predetermined duration, the display module 123 displays the new image (e.g., image b) in the biggest display area replacing the old image (e.g., image a), and displays image a in the second display area. After another duration, the display module 123 displays the new image (e.g., image c) in the biggest display area replacing the old image (image b), displays image b in the second display area replacing image a, and displays image a in the third display area. After a third duration, the display module 123 displays the new image (e.g., image d) in the biggest display area replacing the old image (image c), displays image c in the second display area replacing image b, displays image b in the third display area replacing image a, and displays image a in the fourth display area. After a fourth duration, the display module 123 displays the new image (e.g., image e) in the biggest display area replacing the old image (image d), displays image d in the second display area replacing image c, displays image c in the third display area replacing image b, displays image b in the fourth display area replacing image a, and displays image a in the fifth display area. Therefore, if there are more new images to be displayed on the condition that all the display areas have images thereon, the display module 123 continues to display the new images in the first-in-first-out manner as described above.

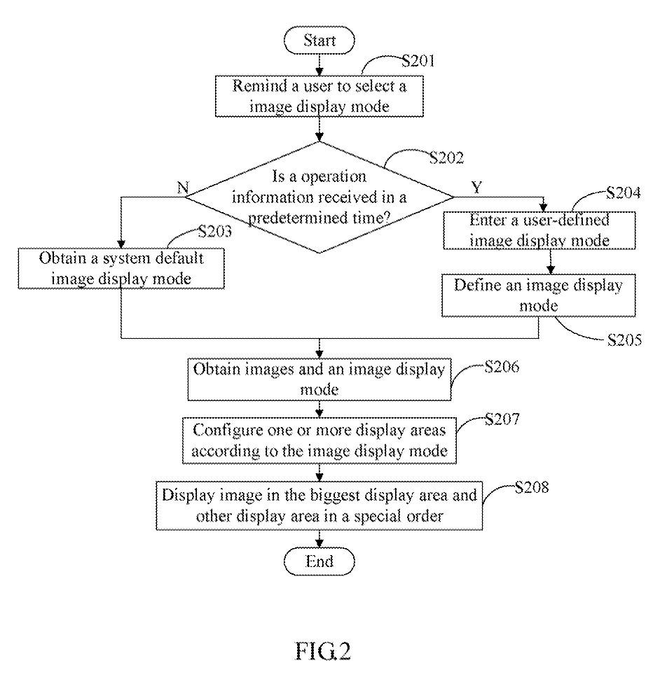

FIG. 2 is a flowchart for a method of displaying images in display areas applied in the digital photo frame of FIG. 1 in accordance with an exemplary embodiment.

In step S201, after being powered on, the digital photo frame reminds the user to select an image display mode. For example, in the exemplary embodiment, the digital photo frame provides the default image display mode and the user-defined image display modes for selection.

In step S202, the processor 12 determines whether an operation signal generated from the input unit 10 is received in a predetermined time, that is, the processor 12 determines whether the user selects an image display mode in the predetermined time.

In step S203, if the processor 12 does not receive the operation signal generated from the input unit 10, the processor obtains the default image display mode, and the procedure goes to S206 described below.

In step S204, if the processor 12 receives the operation signal generated from the input unit 10, the processor 12 determines that the user wants to define the image display mode manually.

In step S205, the processor 12 defines the image display mode according to the operation signal. For example, in response to user input, the processor 12 defines that the total count of images displayable on the display 13 is 3, the duration is 1.0 second, the size of the biggest display area is 6.75 cm(H) by 9.0 cm(W), and the size of each of the other display areas is 3.75 cm(H) by 5.0 cm(W).

In step S206, the reading module 121 obtains images and a image display mode.

In step S207, the assigning module 122 configures one or more display areas in the display 13 according to the image display mode.

In step S208, the display module 123 displays the images that obtained by the reading module 121 on the image display areas in a predetermined order according to the duration.

When the display module 123 displays the last new image that has not yet been displayed, the display module 123 further displays a prompt, for example, a prompt reminding the user that all images have been displayed and whether to select a new image display mode. If the user decides not to select a new image display mode, the display module 123 displays images according to the current image display mode, and if the user decides to select a new image display mode, the display module 123 defines a new image display mode according to the operation signal of the input unit 10 and displays images according to the new image display mode.

Although the present invention has been specifically described on the basis of the exemplary embodiment thereof, the invention is not to be construed as being limited thereto. Various changes or modifications may be made to the embodiment without departing from the scope and spirit of the invention.

What is claimed is:

1. A digital photo frame (DPF) comprising:
an input unit;
a display;
a memory for storing images and image display modes, wherein each of the image display modes defines a total count of a plurality of display areas for displaying a plurality of images on the display, a size of each of display areas, displaying order, and a duration to display image in the biggest display area; and
a processor connected with the memory, the display and the input unit, comprising:
a reading module configured for obtaining images and the image display modes from the memory;
an assigning module configured for configuring the plurality of display areas according to the image display mode; and
a displaying module configured for displaying images in the biggest display areas and the other display areas in the displaying order according to the image display mode.

2. The DPF as described in claim 1, wherein the assigning module is capable of configuring a biggest display area and other display areas with the same size.

3. The DPF as described in claim 1, wherein the display order is an order of displaying images in the biggest display area and in other display areas in one-by-one manner or in first-in-first-out manner.

4. A method of displaying images applied on a digital photo frame (DPF), comprising:
providing a default image display mode and at least one other image display mode, wherein each of the image display modes defines a total count of images displayable on a display defining a biggest display area, a size of each of display areas, display order and an duration to display image in the biggest display area;
obtaining images and one of the image display modes;
configuring one or more display areas according to the image display mode; and
displaying images on the biggest possible display area in the displaying order.

5. The method as described in claim 4, further comprising: when the DPF reminds the user to select a image display mode and an operation signal is not received in a predetermined time, choosing the default image display mode; and if an operation signal is received in the predetermined time, selecting a new image display mode according to the operation signal.

6. The method as described in claim 4, further comprising: displaying a prompt to remind the user that all the images have been displayed when all of images have been displayed in the biggest display area.

7. The method as described in claim 6, further comprising: displaying another prompt to remind the user whether to repeat displaying the image in the selected image display mode, if an operation signal is not received in a predetermined time, repeating displaying images in the selected image display mode; and if the operation signal is received in the predetermined time, selecting a new image display mode according to the operation signal, and displaying the images according to the new image display mode.
